(19) United States
(12) Patent Application Publication
(10) Pub. No.: US 2026/0161586 A1
(43) Pub. Date: Jun. 11, 2026

(54) DMA CONTROLLER FOR HANDLING MULTI-DESTINATION TRANSFER REQUESTS

(71) Applicant: Texas Instruments Incorporated, Dallas, TX (US)

(72) Inventors: David Smith, Allen, TX (US); Eric Lasmana, Plano, TX (US); Chunhua Hu, Plano, TX (US); Vignesh Raghavendra, Bangalore (IN)

(21) Appl. No.: 19/253,311

(22) Filed: Jun. 27, 2025

Related U.S. Application Data
(60) Provisional application No. 63/728,237, filed on Dec. 5, 2024.

(51) Int. Cl. G06F 13/28

(52) U.S. Cl. CPC G06F 13/28

(57) ABSTRACT

Various embodiments of the present disclosure relate to handling multi-destination transfer requests within the context of a system that implements a DMA controller including control circuitry and a transmit buffer. In one example embodiment a technique for responding to a request to transfer data from a source to multiple destinations is provided. The technique first includes, by the control circuitry, controlling the transferring of the data from the source to the transmit buffer. Next the technique includes, by the control circuitry, controlling the transferring of the data from the transmit buffer to a first destination of the multiple destinations. Finally, the technique includes, by the control circuitry, controlling the transferring of the data from the transmit buffer to a second destination of the multiple destinations.

### CROSS-REFERENCE TO RELATED APPLICATION

This application is related to, and claims the benefit of priority to, U.S. Provisional Patent Application No. 63/728,237, filed on Dec. 5, 2024, and entitled “DIRECT MEMORY ACCESS TRANSFER SUPPORTING MULTIPLE DESTINATIONS”, which is hereby incorporated by reference in its entirety.

### TECHNICAL FIELD

Aspects of the disclosure are related to direct memory access (DMA) controllers, and in particular, to handling multi-destination transfer requests.

### BACKGROUND

A DMA controller is a device that facilitates data transfers between the various components of an associated system. For example, in a system including a DMA controller coupled to multiple memories and multiple peripherals, the DMA controller may receive a request to transfer data from a memory to a peripheral, from a peripheral to a memory, between peripherals, or between memories. More generally, the DMA controller may be requested to transfer data from a high-latency, or low-latency source, to a high-latency, or low-latency destination.

In existing low-cost systems, DMA controllers are typically limited to handling transfer requests that specify a single destination. As a result, current techniques for performing multi-destination data transfers within the context of such systems require issuing multiple single-destination transfer requests. For example, when starting up a system, the DMA controller may receive a first request to transfer a boot-up image from an external memory to an authentication engine that verifies the integrity of the boot-up image. The DMA controller may then receive a second request to transfer the same boot-up image from the external memory to a memory associated with a central processing unit (CPU) that initiates the system startup. Accordingly, the DMA controller must read the boot-up image from the external memory twice.

Problematically, most external memories, such as flash memory, are high latency devices. As a result, requiring multiple read operations from such memories during system startup increases the overall startup time. Additionally, a brief window of time exists for when the authentication engine is verifying the boot-up image, and the DMA controller is performing the second read of the boot-up image from external memory. Consequently, during this window, the boot-up image may become corrupted. As a result, the DMA controller cannot guarantee that the second read of the boot-up image is identical to the first, potentially rendering the authentication process ineffective while jeopardizing the system startup.

### SUMMARY

Disclosed herein is technology, including systems, methods, and devices for handling multi-destination transfer requests within the context of low-cost systems that implement a DMA controller.

In one example embodiment, DMA circuitry includes a transmit buffer and control circuitry coupled to the transmit buffer. In an implementation, the control circuitry is first configured to, in response to a request to transfer data from a source to multiple destinations, control the transferring of the data from the source to the transmit buffer. Next the control circuitry is configured to control the transferring of the data from the transmit buffer to a first destination of the multiple destinations. Finally, the control circuitry is configured to control the transferring of the data from the transmit buffer to a second destination of the multiple destinations.

In a second example embodiment, transmit channel circuitry includes a transmit buffer and control circuitry. In an implementation, the control circuitry is first configured to, in response to a request to transfer data from a source to multiple destinations, control the transferring of the data from the source to the transmit buffer. Next the control circuitry is configured to control the transferring of the data from the transmit buffer to a first destination of the multiple destinations. Finally, the control circuitry is configured to control the transferring of the data from the transmit buffer to a second destination of the multiple destinations.

In a third example embodiment, a system includes processing circuitry and DMA circuitry coupled to the processing circuitry, such that the DMA circuitry includes a transmit buffer and control circuitry. In an implementation, the processing circuitry is configured to send a multi-destination transfer request for data to the DMA circuitry. In response, the control circuitry of the DMA circuitry is first configured to control the transferring of the data from a source to the transmit buffer. Next, the control circuitry is configured to control the transferring of the data from the transmit buffer to a first destination of multiple destinations. Finally, the control circuitry is configured to control the transferring of the data from the transmit buffer to a second destination of the multiple destinations.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIG. 2 illustrates a method in an implementation.

FIG. 3 illustrates a sequence diagram in an implementation.

FIG. 4 illustrates another system in an implementation.

FIG. 5 illustrates another sequence diagram in an implementation.

FIG. 6 illustrates another system in an implementation.

FIG. 7 illustrates a state machine process in an implementation.

FIG. 8 illustrates an operational scenario in an implementation.

### DETAILED DESCRIPTION

Systems, methods, and devices are disclosed herein which provide an improved process for handling multi-destination transfer requests within the context of a low-cost system that employs a DMA controller. The disclosed technique(s) may be implemented in hardware, software, firmware, or a combination thereof to provide a DMA controller that is capable of transferring data to multiple destinations in tandem. Advantageously, the proposed technology provides a DMA controller which reduces the processing times for starting up the associated system.

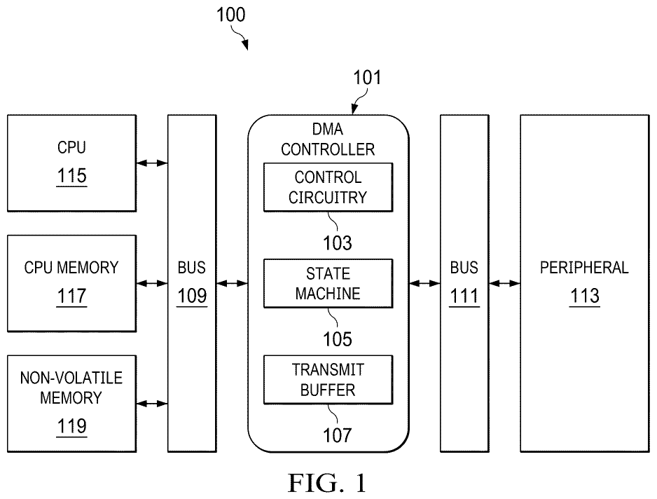

FIG. 1 illustrates system 100 in an implementation. System 100 is representative of an exemplary system that employs a DMA controller for performing various data transfer operations. For example, system 100 may depict a low-cost system, such as an automotive system, industrial system, or consumer device, that utilizes a DMA controller for performing single-or multi-destination data transfers. System 100 includes, but is not limited to, DMA controller 101, data buses 109 and 111, peripheral 113, CPU 115, CPU memory 117, and non-volatile memory 119.

DMA controller 101 represents circuitry that manages the data transfers between the components of system 100. For example, DMA controller 101 may include multiple channels for transferring data between non-volatile memory 119, CPU memory 117, and peripheral 113. In an implementation, DMA controller 101 receives transfer requests from the components of system 100. A transfer request refers to a request for data to be moved from a source to one or more destinations. For example, DMA controller 101 may receive single-destination transfer requests or multi-destination transfer requests. A single-destination transfer request refers to a request for data to be transferred from a source to a single destination, while a multi-destination transfer request refers to a request for data to be transferred from a source to multiple destinations. DMA controller 101 includes, but is not limited to, control circuitry 103, state machine 105, and transmit buffer 107.

Control circuitry 103 is representative of circuitry that manages the operations of DMA controller 101. For example, control circuitry 103 may depict one or more cores of a CPU, microcontroller unit (MCU), application-specific integrated circuit (ASIC), or another general-purpose processor (GPP) of the like that manages the read and write operations required for servicing a transfer request. In an implementation, control circuitry 103 interfaces with state machine 105 to service transfer requests. It should be noted that state machine 105 may be incorporated into control circuitry 103, but for the purposes of explanation, state machine 105 will be explained as a separate component. This is not meant to limit the applications of state machine 105, but rather, to provide an example.

State machine 105 is representative of a logical component that interprets received transfer requests. For example, state machine 105 may depict hardware, software, firmware, or a combination thereof that determines whether a received transfer request (e.g., a combined read and write request) is a single-destination transfer request, or a multi-destination transfer request based on a transfer descriptor for the request. The transfer descriptor refers to an indicator that defines the parameters for the request, including where the data should be read from, where the data should be written to, and the size of the data to be transferred. For example, the transfer descriptor may include one or more bit-fields that specify a source address for reading the data, one or more destination addresses for writing the data, and the number of bytes within the data.

During operation, state machine 105 analyzes the transfer descriptors of received transfer requests to determine if the requests are single-destination transfer requests or multi-destination transfer requests. For example, if state machine 105 identifies a single destination address within a transfer descriptor, then state machine 105 classifies the corresponding request as a single-destination transfer request. Alternatively, if state machine 105 identifies multiple destination addresses within a transfer descriptor, then state machine 105 classifies the corresponding request as a multi-destination transfer request. In an implementation, the transfer descriptor for a multi-destination transfer request may specify destination addresses that correspond to multiple memory locations, multiple peripheral locations, or a combination of memory and peripheral locations. For example, the transfer descriptor may identify a first destination address corresponding to a first location within CPU memory 117 and a second destination address corresponding to a second location within CPU memory 117. Alternatively, the transfer descriptor may identify a first destination address corresponding to a first peripheral and a second destination address corresponding to a second peripheral. Conversely, the transfer descriptor may identify a first destination address corresponding to a location within CPU memory 117 and a second destination address corresponding to peripheral 113.

In an implementation, after state machine 105 classifies a transfer request as either a single-destination or multi-destination transfer request, state machine 105 informs control circuitry 103 of the classification, and in response, control circuitry 103 executes the read and write operations required for servicing the transfer request. For example, control circuitry 103 may include read circuitry that, when directed, reads data from a source to transmit buffer 107, as well as write circuitry that, when directed, writes data from transmit buffer 107 to the intended destination(s).

Transmit buffer 107 serves as a local memory for DMA controller 101. For example, transmit buffer 107 may store the data of various transfer requests. In an implementation, transmit buffer 107 depicts a first-in, first-out (FIFO) buffer that ensures data is transmitted in the order that it was received. For example, control circuitry 103 may store data corresponding to a first transfer request within transmit buffer 107 and subsequently store data corresponding to a second transfer request within transmit buffer 107, such that the data of the first transfer request is intended for CPU memory 117 and the data of the second transfer request is intended for peripheral 113. Control circuitry 103 may then supply the data of the first transfer request to CPU memory 117 via data bus 109. Once supplied, control circuitry 103 may then supply the data of the second transfer request to peripheral 113 via data bus 111.

Data buses 109 and 111 are representative of circuitry that connect DMA controller 101 to the remaining components of system 100. For example, data bus 109 may depict a crossbar switch which connects DMA controller 101 to CPU 115, CPU memory 117, and non-volatile memory 119. Alternatively, data bus 111 may depict another crossbar switch which connects DMA controller 101 to peripheral 113. In an implementation, data buses 109 and 111 are representative of the same component, but for the purposes of explanation, data bus 109 and data bus 111 will be explained separately.

Peripheral 113 represents circuitry that serves as either a source or a destination for the data transfers managed by DMA controller 101. For example, peripheral 113 may depict a serial communication interface (e.g., UART, SPI, I2C, etc.), a sensor interface, a memory interface, or another data-producing/data-consuming interface of the like which exchanges data through DMA controller 101. It should be noted that, although illustrated as a single device, peripheral 113 may encompass a set of different peripherals, but for the purposes of explanation, peripheral 113 will be discussed as a single peripheral. More specifically, peripheral 113 will be discussed as an authentication engine. This specification is not meant to limit the applications of peripheral 113, but rather to provide an example.

In an implementation, peripheral 113 is a low-latency authentication engine that verifies the integrity of data as read from memory. For example, peripheral 113 may include a cryptographic intellectual property (crypto IP) core that performs various cryptographic functions (e.g., hashing, decryption, encryption, etc.) on the data read from non-volatile memory 119. In an implementation, peripheral 113 verifies the integrity of a boot-up image read from non-volatile memory 119. The boot-up image refers to data which allows CPU 115 to start-up system 100. For example, the boot-up image may include program code that causes CPU 115 to configure the components of system 100.

CPU 115 is representative of any type of processing circuitry (e.g., one or more cores of a CPU, MCU, ASIC, and/or another GPP) that manages the operations of system 100. For example, if system 100 is implemented within the automotive context, then CPU 115 may execute program code related to motor control, airbag deployment, infotainment, and other functionalities of the like. Additionally, CPU 115 may execute program code for starting up system 100. For example, CPU 115 may output a multi-destination transfer request that causes DMA controller 101 to transfer the boot-up image stored by non-volatile memory 119 to both peripheral 113 and CPU memory 117. In response, peripheral 113 authenticates the boot-up image and provides confirmation of the authentication to CPU 115. Once provided, CPU 115 accesses the program code of the boot-up image from CPU memory 117 and starts up system 100.

CPU memory 117 is representative of a memory that stores data, instructions, and the like for CPU 115. For example, CPU memory 117 may depict cache memory, static random-access memory (SRAM), dynamic random-access memory (DRAM), or another on-chip memory of the like which stores program code for CPU 115, such that in no case is CPU memory 117 a propagated signal. In an implementation, CPU 115 generates transfer requests which cause DMA controller 101 to transfer data from non-volatile memory 119 to CPU memory 117.

Non-volatile memory 119 is representative of a memory that stores data, instructions, and the like for system 100. For example, non-volatile memory 119 may depict flash memory, DRAM, read-only memory (ROM), or another external memory of the like, such that in no case is non-volatile memory 119 a propagated signal. In an implementation, non-volatile memory 119 is a high-latency memory which stores the boot-up image for starting up system 100.

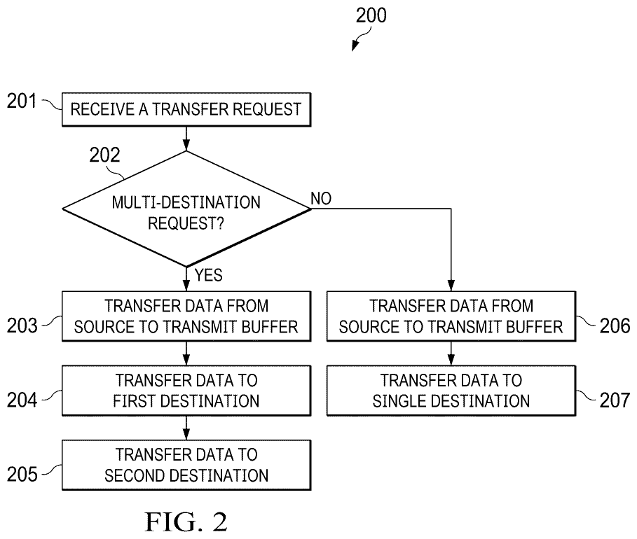

FIG. 2 illustrates control method 200 in an implementation. Control method 200 is representative of a technique for performing the various data transfer operations of a DMA controller. For example, control method 200 may provide a technique for servicing single-destination transfer requests and multi-destination transfer requests within the context of a low-cost system that employs a DMA controller. Control method 200 may be implemented in the context of hardware, firmware, or software to cause a system to operate as follows, referring parenthetically to the steps in FIG. 2. For the purposes of explanation, control method 200 will be explained with respect to the elements of FIG. 1. This is not meant to limit the applications of control method 200, but rather to provide an example for purposes of illustration.

To begin, DMA controller 101 receives a transfer request from a component of system 100 and provides the transfer request to state machine 105 (step 201). For example, CPU 115 may output a transfer request to DMA controller 101, and in response, DMA controller 101 may provide the request to state machine 105. Once provided, state machine 105 may analyze the transfer descriptor of the request to determine if the request is a single-destination transfer request or a multi-destination transfer request (step 202). For example, state machine 105 may analyze a set of bit fields that specify a source address for reading the data, one or more destination addresses for writing the data, and the number of bytes within the data.

In an implementation, if state machine 105 identifies multiple destination addresses within the transfer descriptor, then state machine 105 classifies the request as a multi-destination transfer request and supplies the identified source address, destination addresses, and data size to control circuitry 103. For example, state machine 105 may provide a source address corresponding to a location within non-volatile memory 119, a first destination address corresponding to peripheral 113, a second destination address corresponding to a location within CPU memory 117, and the number of bytes to be transferred to control circuitry 103.

In response, control circuitry 103 may transfer the data from the location within non-volatile memory 119 to transmit buffer 107 (step 203). For example, control circuitry 103 may direct its read circuitry to read the appropriate number of bytes from the location within non-volatile memory 119 to transmit buffer 107. Once read, control circuitry 103 may then transfer the data from transmit buffer 107 to peripheral 113 (step 204). For example, control circuitry 103 may direct its write circuitry to transfer the data from transmit buffer 107 to peripheral 113. In response, peripheral 113 may verify the integrity of the data. For example, peripheral 113 may compute a hash for the data and compare the computed hash to a trusted hash. If the hashes do not match, then peripheral 113 provides a warning to CPU 115. Alternatively, if the hashes do match, then control circuitry 103 may transfer the data from transmit buffer 107 to CPU memory 117 (step 205). For example, control circuitry 103 may direct its write circuitry to transfer the data from transmit buffer 107 to the appropriate location within CPU memory 117.

In another implementation, if state machine 105 identifies a single destination address, then state machine 105 classifies the request as a single-destination transfer request and supplies the identified source address, destination address, and data size to control circuitry 103. For example, state machine 105 may provide a source address corresponding to a location within non-volatile memory 119, a destination address corresponding to a location within CPU memory 117, and the number of bytes to be transferred to control circuitry 103.

In response, control circuitry 103 may transfer the data from the location within non-volatile memory 119 to transmit buffer 107 (step 206). For example, control circuitry 103 may direct its read circuitry to read the appropriate number of bytes from the location within non-volatile memory 119 to transmit buffer 107. Once read, control circuitry 103 may then transfer the data from transmit buffer 107 to CPU memory 117 (step 207). For example, control circuitry 103 may direct its write circuitry to transfer the data from transmit buffer 107 to the appropriate location within CPU memory 117.

Advantageously, control method 200 provides a technique that reduces the processing times for performing multi-destination data transfers within the context of a low-cost system that employs a DMA controller. More specifically, control method 200 provides a technique for servicing multi-destination transfer requests that only requires a single read from a high latency memory, such as flash memory. As a result, control method 200 provides a technique that reduces the processing times for starting up an associated system. Additionally, control method 200 provides a technique that ensures the data remains uncorrupted during the transfer process, thereby enhancing the reliability and performance of the associated system.

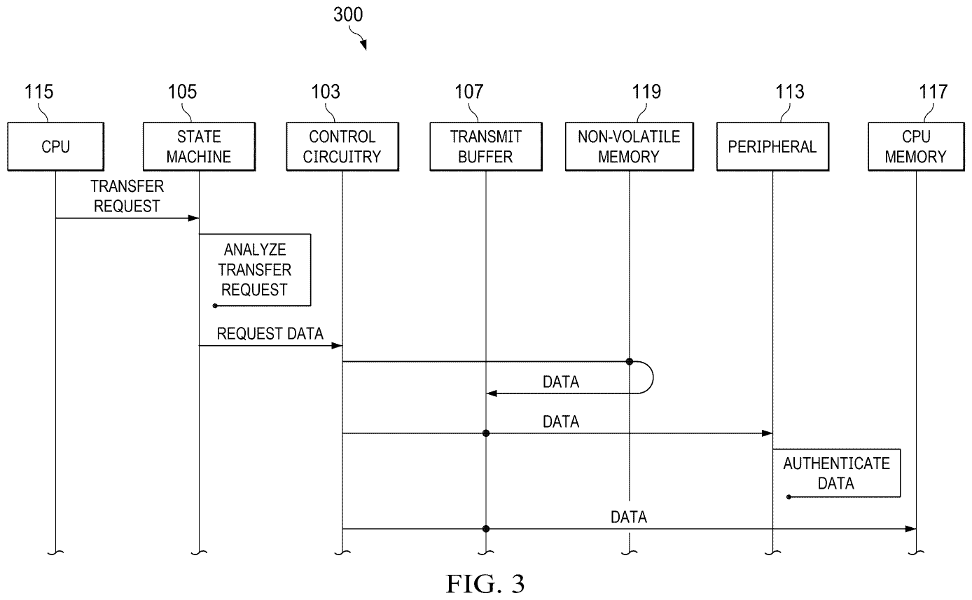

FIG. 3 illustrates sequence diagram 300 in an implementation. Sequence diagram 300 is representative of an operational sequence for servicing a multi-destination transfer request with respect to the elements of FIG. 1. In an implementation, sequence diagram 300 provides an operational sequence for starting up system 100. Sequence diagram 300 includes CPU 115, state machine 105, control circuitry 103, transmit buffer 107, non-volatile memory 119, peripheral 113, and CPU memory 117.

To begin, CPU 115 generates a transfer request to start-up system 100. For example, CPU 115 may request the boot-up image stored by non-volatile memory 119 to be transferred to peripheral 113 and CPU memory 117. Next, CPU 115 supplies the transfer request to state machine 105, and in response, state machine 105 analyzes the corresponding transfer descriptor to determine if the request is a single-destination transfer request or a multi-destination transfer request. For example, state machine 105 may determine that the request is a multi-destination transfer request for transferring the boot-up image from a location within non-volatile memory 119 to both peripheral 113 and a location within CPU memory 117.

Next, state machine 105 request data to control circuitry 103. For example, state machine 105 may provide the source address for the boot-up image, the destination addresses for the boot-up image, and a number of bytes within the boot-up image to control circuitry 103. In response, control circuitry 103 directs its read circuitry to read the number of bytes corresponding to the boot-up image from the appropriate location within non-volatile memory 119 to transmit buffer 107. Control circuitry 103 then directs its write circuitry to transfer the boot-up image from transmit buffer 107 to peripheral 113.

Once transferred, peripheral 113 authenticates the boot-up image. For example, peripheral 113 may compute a hash for the boot-up image and compare the computed hash to a trusted hash for the boot-up image. If the hashes don't match, then peripheral 113 provides a warning to CPU 115 indicating that the system start-up has failed. Alternatively, if the hashes do match, then control circuitry 103 directs its write circuitry to transfer the boot-up image from transmit buffer 107 to CPU memory 117. In response, CPU 115 accesses the boot-up image from CPU memory 117 and begins to configure system 100.

In some examples, by only a storing a single copy of the data in transmit buffer 107 and by only providing that copy from transmit buffer 107 to the multiple destinations, there may be less opportunity to maliciously modify the data without detection by peripheral 113.

In some examples, instead of waiting for a response from peripheral 113 to transfer data from transmit buffer 107 to subsequent destinations (e.g., CPU memory 117), control circuitry 103 causes data to be transferred to some or all destinations concurrently. In one such example, a boot-up image is transferred from transmit buffer 107 to peripheral 113 and to CPU memory 117 concurrently. This allows CPU 115 to begin executing the boot-up image before peripheral 113 has completely verified the integrity of the boot-up image. This may speed up the boot process and reduce an opportunity to modify the boot-up image between the verification and the execution. In the event that the verification fails, peripheral 113 can provide a signal to CPU 115 to halt the in-progress execution of the boot-up-image.

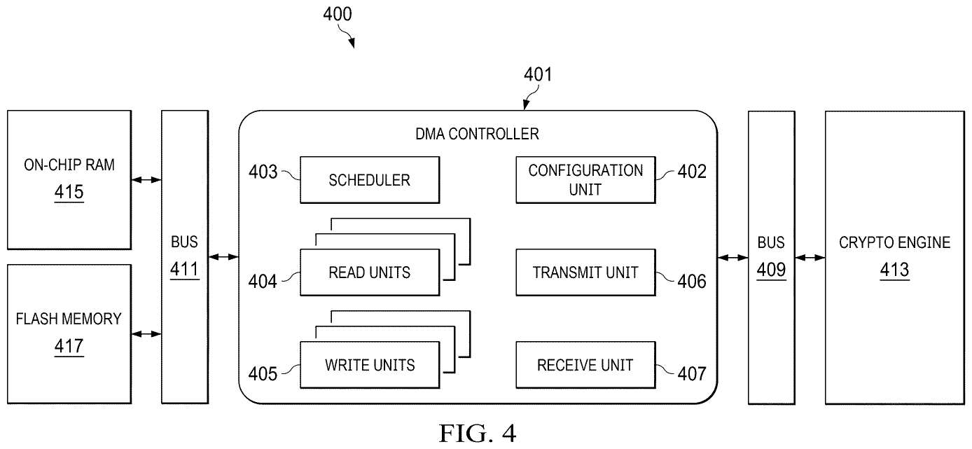

FIG. 4 illustrates system 400 in an implementation. System 400 is representative of another exemplary system that employs a DMA controller for performing various data transfer operations. For example, system 400 may represent system 100 of FIG. 1. System 400 includes, but is not limited to, DMA controller 401, data buses 409 and 411, crypto engine 413, on-chip RAM 415, and flash memory 417.

DMA controller 401 is representative of circuitry that transfers data between the components of system 400. For example, DMA controller 401 may be representative of DMA controller 101 of FIG. 1. In an implementation, DMA controller 401 receives single-destination transfer requests and multi-destination transfer requests from the components of system 400. A single-destination transfer request refers to a request for data to be transferred from a source to a single destination. Alternatively, a multi-destination transfer request refers to a request for data to be transferred from a source to multiple destinations. DMA controller 401 includes configuration unit 402, scheduler 403, read units 404, write units 405, transmit unit 406, and receive unit 407.

Configuration unit 402 is representative of circuitry that determines if the received transfer requests are single-destination transfer requests or multi-destination transfer requests. For example, configuration unit 402 may depict a CPU, MCU, ASIC, or another GPP of the like that receives the transfer requests, and in response, analyzes the transfer descriptors of the received requests. A transfer descriptor refers to an indicator that defines the parameters for the transfer request, including where the data should be read from, where the data should be written to, and the size of the data to be transferred. For example, the transfer descriptor may include one or more bit-fields that specify the source address for the data, one or more destination addresses for the data, and the number of bytes within the data. If configuration unit 402 identifies multiple destination addresses within the transfer descriptor, then configuration unit 402 classifies the request as a multi-destination transfer request. Alternatively, if configuration unit 402 identifies a single destination address within the transfer descriptor, then configuration unit classifies the request as a single-destination transfer request.

In an implementation, if configuration unit 402 classifies a request as a multi-destination transfer request, and the source address for servicing the request corresponds to an address within flash memory 417, then configuration unit 402 informs transmit unit 406 of the multi-destination transfer request. For example, configuration unit 402 may enable a register that is associated with transmit unit 406. More specifically, configuration unit 402 may enable a configuration register that, when enabled, instructs transmit unit 406 to service a multi-destination transfer request. Alternatively, if configuration unit 402 classifies a request as a single-destination transfer request, and the source address for servicing the request corresponds to an address within flash memory 417, then configuration unit 402 informs transmit unit 406 of the single-destination transfer request. For example, configuration unit 402 may disable the configuration register, thereby instructing transmit unit 406 to service a single-destination transfer request. In an implementation, the configuration register is housed by transmit unit 406.

Transmit unit 406 is representative of circuitry that provides channels for transferring data from an external memory to the remaining components of system 400. For example, transmit unit 406 may depict a CPU, MCU, ASIC, or another GPP of the like, including a first transmit channel for transferring data from flash memory 417, a second transmit channel for transferring data to on-chip RAM 415, and a third transmit channel for transferring data to crypto engine 413. In an implementation, transmit unit 406 also includes a state machine (e.g., state machine 105) and a FIFO buffer.

The state machine manages the various read and write operations for servicing single-destination and multi-destination transfer requests, while the FIFO buffer stores the data to be transferred. For example, the state machine may monitor the availability of the FIFO buffer to determine when to read data from, or write data to, the buffer. If the state machine determines that the FIFO buffer is full, then the state machine instructs scheduler 403 to schedule a write operation. Alternatively, if the state machine determines that the FIFO buffer is not full, then the state machine instructs scheduler 403 to schedule a read operation. Additionally, the state machine may track which data corresponds to a multi-destination transfer request and which data corresponds to a single-destination transfer request within the FIFO buffer. For example, when data is written into the FIFO buffer, the state machine may check the configuration register to determine if the data corresponds to a multi-destination transfer request or a single-destination transfer request.

Receive unit 407 is representative of circuitry that provides channels for transferring data to an external memory. For example, receive unit 407 may depict a CPU, MCU, ASIC, or another GPP of the like, including a first receive channel for transferring data to flash memory 417, a second receive channel for transferring data from on-chip RAM 415, and a third receive channel for transferring data from crypto engine 413. In an implementation, receive unit 407 also includes a buffer for storing data. For example, receive unit 407 may include a FIFO buffer that temporarily stores data for flash memory 417. In an implementation, if receive unit 407 determines that its buffer is full, then receive unit 407 instructs scheduler 403 to schedule a write operation. Alternatively, if receive unit 407 determines that its buffer is not full, then receive unit 407 instructs scheduler 403 to schedule a read operation.

Scheduler 403 is representative of circuitry that schedules the operations performed by DMA controller 401. For example, scheduler 403 may depict a CPU, MCU, ASIC, or another GPP of the like that determines the order of operations for servicing multiple transfer requests in tandem. In an implementation, scheduler 403 schedules the read and write operations respectively performed by read units 404 and write units 405. For example, if transmit unit 406 directs scheduler 403 to supply data to its FIFO buffer, then scheduler 403 may determine when to instruct read units 404 to read the desired data from flash memory 417. Alternatively, if transmit unit 406 directs scheduler 403 to remove data from its FIFO buffer, then scheduler 403 may determine when to instruct write units 405 to transfer the desired data to the intended destinations. In an implementation, to determine when to schedule the read and write operations for servicing multiple transfer requests, scheduler 403 analyzes the availability of data bus 409, data bus 411, the transmit channels of transmit unit 406, and the receive channels of receive unit 407. For example, scheduler 403 may identify the active pathways of data buses 409 and 411 and the active transmit and receive channels of transmit unit 406 and receive unit 407.

Read units 404 and write units 405 are representative of circuitry that respectively perform read and write operations. For example, read units 404 may read data from flash memory 417, on-chip RAM 415, or crypto engine 413, and supply the data to the appropriate FIFO buffer. Alternatively, write units 405 may transfer data stored by the FIFO buffers to the intended destinations. In an implementation, read units 404 and write units 405 respectively read or write data when instructed by scheduler 403. For example, when instructed by scheduler 403, read units 404 may read data from flash memory 417 to the FIFO buffer of transmit unit 406. In another example, when instructed by scheduler 403, write units may transfer data from the FIFO buffer of transmit unit 406 to the intended destination(s). In an implementation, read units 404 and write units 405 exchange data with the components of system 400 via data buses 409 and 411.

Data buses 409 and 411 are representative of circuitry (e.g., data buses 109 and 111) that connect DMA controller 401 to the remaining components of system 400. For example, data bus 409 may depict a crossbar switch that provides pathways for connecting read units 404 and write units 405 to on-chip RAM 415 and flash memory 417. Alternatively, data bus 411 may depict another crossbar switch that provides pathways for connecting read units 404 and write units 405 to crypto engine 413. In an implementation, data buses 409 and 411 are representative of the same component, but for the purposes of explanation, data buses 409 and 411 will be explained separately.

Crypto engine 413 is representative of circuitry that verifies the integrity of data stored by flash memory 417. For example, crypto engine 413 may depict peripheral 113 of FIG. 1. In an implementation, crypto engine 413 depicts a crypto IP core that performs various cryptographic functions, such as encryption, decryption, hashing, digital signature generation, and key management. During operation, crypto engine 413 receives data from write units 405, and in response, verifies the integrity of the data. For example, crypto engine 413 may compute a hash for the received data and compare the computed hash to a trusted hash for the data. If the hashes do not match, then crypto engine 413 outputs a warning (e.g., interrupt) indicating that the data has been corrupted. Alternatively, if the hashes do match, then crypto engine 413 provides a verification indicating that the data has not been corrupted.

On-chip RAM 415 is representative of a memory that stores data, instructions, and the like for an associated CPU. For example, on-chip RAM 415 may depict CPU memory 117 of FIG. 1. In an implementation, the CPU associated with on-chip RAM 415 generates transfer requests for data to be transferred from flash memory 417 to on-chip RAM 415, and or crypto engine 413.

Flash memory 417 is representative of a high-latency memory that stores data, instructions, and the like for system 400. For example, flash memory 417 may depict non-volatile memory 119 of FIG. 1. In an implementation, flash memory 417 stores a boot-up image for starting up system 400. The boot-up image refers to a collection of data which causes the associated CPU to configure the components of system 400.

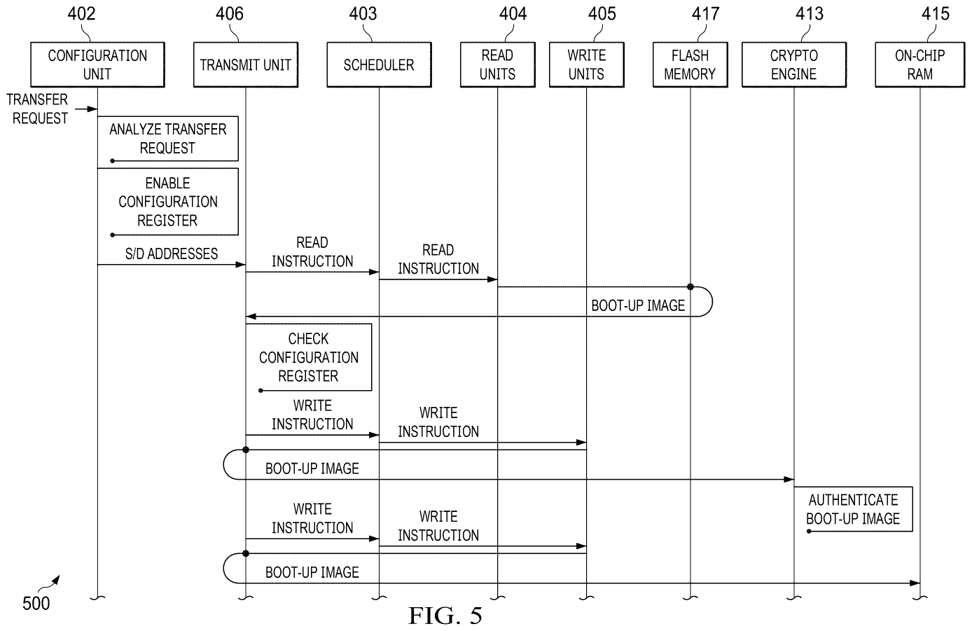

FIG. 5 illustrates sequence diagram 500 in an implementation. Sequence diagram 500 is representative of an operational sequence for starting up system 400. As such, sequence diagram 500 includes configuration unit 402, transmit unit 406, scheduler 403, read units 404, write units 405, flash memory 417, crypto engine 413, and on-chip RAM 415.

To begin the start-up of system 400, an associated CPU supplies a transfer request to configuration unit 402. For example, the associated CPU may request for the boot-up image stored by flash memory 417 to be transferred to crypto engine 413 and on-chip RAM 415. Next, configuration unit 402 analyzes the transfer descriptor of the request to determine if the request is a single-destination transfer request or a multi-destination transfer request. For example, configuration unit 402 may determine that the transfer descriptor provides two destination addresses, including a first destination address which corresponds to crypto engine 413 and a second destination address which corresponds to a location in on-chip RAM 415. Additionally, configuration unit 402 may determine that the source address identified by the transfer descriptor corresponds to a location in flash memory 417. As a result, configuration unit 402 classifies the request as a multi-destination transfer request, and in response, enables the configuration register.

Next, configuration unit 402 provides the source address and the destination addresses for the transfer request to transmit unit 406, and in response, transmit unit 406 outputs a read instruction to scheduler 403. For example, transmit unit 406 may instruct scheduler 403 to schedule a read operation for accessing the boot-up image from the location in flash memory 417 that corresponds to the source address. In response, scheduler 403 analyzes the availability of data bus 411 and the transmit channels of transmit unit 406 and determines that the necessary pathways for accessing the boot-up image are available. Once determined, scheduler 403 outputs a read instruction to read units 404. For example, scheduler 403 may instruct read units 404 to transfer the boot-up image to the FIFO buffer of transmit unit 406 via the appropriate transmit channel.

Once transferred, the state machine of transmit unit 406 analyzes the configuration register to determine if the boot-up image corresponds to a multi-destination transfer request or a single-destination transfer request. For example, the state machine may determine that the configuration register has been enabled, and in response, determines that the boot-up image corresponds to a multi-destination transfer request. Next, transmit unit 406 outputs a write instruction to scheduler 403. For example, transmit unit 406 may instruct scheduler 403 to schedule a write operation for transferring the boot-up image to crypto engine 413. In response, scheduler 403 analyzes the availability of data bus 409 and the channels of transmit unit 406 and determines that the necessary pathways for transferring the boot-up image are available. Once determined, scheduler 403 outputs a write instruction to write units 405. For example, scheduler 403 may instruct write units 405 to write the boot-up image to crypto engine 413 via the appropriate transmit channel.

Next, crypto engine 413 authenticates the integrity of the boot-up image. For example, crypto engine 413 may compute a hash for the boot-up image and compare the computed hash to a trusted hash for the boot-up image. If crypto engine 413 determines that the computed hash does not match the trusted hash, then crypto engine 413 outputs a warning. For example, crypto engine 413 may output an interrupt that halts the start-up process. Alternatively, if crypto engine 413 determines that the computed hash matches the trusted hash, then system 400 continues with the start-up process. For example, transmit unit 406 may instruct scheduler 403 to schedule a write operation for transferring the boot-up image to on-chip RAM 415.

In response, scheduler 403 analyzes the availability of data bus 411 and the channels of transmit unit 406 and determines that the necessary pathways for writing the boot-up image to on-chip RAM 415 are available. Once determined, scheduler 403 outputs a write instruction to write units 405. For example, scheduler 403 may instruct write units 405 to write the boot-up image to on-chip RAM 415 via the appropriate transmit channel. As a result, the CPU associated with on-chip RAM 415 may access the uncorrupted boot-up image and configure the components of system 400.

Advantageously, sequence 500 provides an operational sequence that reduces the processing times for starting up a system. Additionally, sequence 500 demonstrates an operational sequence that preserves the integrity of data during a transfer process. As a result, sequence 500 provides an operational sequence that enhances the reliability and performance of the associated system.

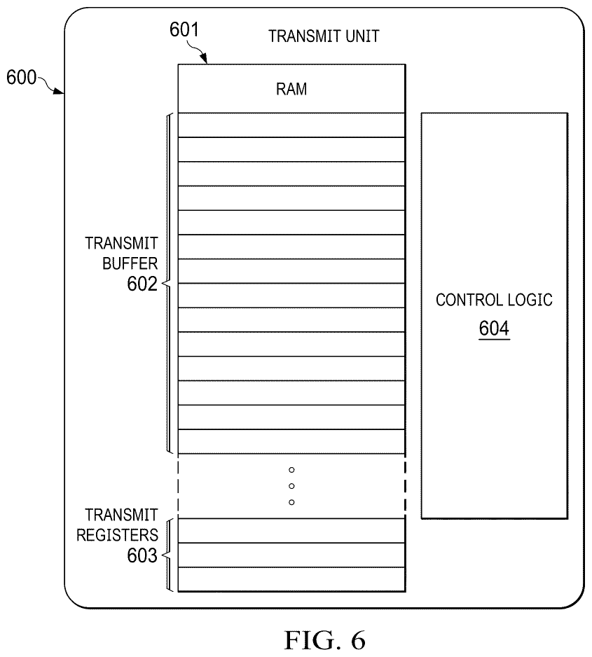

FIG. 6 illustrates transmit unit 600 in an implementation. Transmit unit 600 represents the transmit circuitry of a DMA controller. For example, transmit unit 600 may depict control circuitry 103 of FIG. 1, or transmit unit 406 of FIG. 4. Transmit unit 600 includes RAM 601 and control logic 604.

RAM 601 represents the memory of transmit unit 600. For example, RAM 601 may correspond to a portion of memory (e.g., CPU memory 117 or on-chip RAM 415) that functions as the local memory for transmit unit 600. In an implementation, RAM 601 includes transmit buffer 602 and transmit registers 603. Transmit buffer 602 (e.g., transmit buffer 107) represents the locations in memory which are dedicated to storing transmission data. For example, transmit buffer 602 may store the data that was written to transmit unit 600. In an implementation, transmit buffer 602 depicts a FIFO buffer.

Alternatively, transmit registers 603 represent the locations in memory which are dedicated to storing control information. For example, transmit registers 603 may include registers that store pointer values and transfer values. Within the context of transmit buffer 602, a pointer value is a variable that indicates the current location where data can be read-from or written to, while a transfer value is a variable that indicates the amount of data that is available to transfer. In an implementation, transmit registers 603 include three pointer registers storing various pointer values and two transfer registers storing various transfer values. It should be noted that transmit registers 603 are not limited to such specifications, but for the purposes of explanation, three pointer registers and two transfer registers will be discussed herein.

The first pointer register stores a pointer value indicating the current location where data may be written to transmit buffer 602. For example, if transmit buffer 602 is empty, then the first pointer register may indicate that data should be written to the first cell location of transmit buffer 602. Conversely, the second and third pointer registers store pointer values indicating the current locations where data may be read from transmit buffer 602. For example, if the DMA controller housing transmit unit 600 is connected to a crypto IP core and an on-chip memory of an associated CPU, then the second pointer register may indicate the location within transmit buffer 602 from which data is accessed for writing to the crypto IP core, while the third pointer register may indicate the location within transmit buffer 602 from which data is accessed for writing to the on-chip memory.

Meanwhile, the first and second transfer registers store transfer values that indicate the current amount of data that is available for transmission. For example, if the DMA controller housing transmit unit 600 is connected to a crypto IP core and an on-chip memory of an associated CPU, then the first transfer register may indicate the amount of data within transmit buffer 602 that is ready to be transferred to the crypto IP core, while the second transfer register may indicate the amount of data within transmit buffer 602 that is ready to be transferred to the on-chip memory.

In an implementation, transmit registers 603 also include an availability register and multiple configuration registers. The availability register refers to a transmit register that stores an availability value indicating the current storage capacity of transmit buffer 602. For example, the availability register may indicate how much room is left within transmit buffer 602 for storing data. Alternatively, the configuration registers refer to transmit registers that specify the type of transfer request that the data of transmit buffer 602 is associated with. For example, if a configuration register is enabled, then the associated data corresponds to a multi-destination transfer request. Conversely, if the configuration register is disabled, then the associated data corresponds to a single-destination transfer request. In an implementation, control logic 604 monitors the configuration registers of transmit registers 603 to determine if the data of transmit buffer 602 corresponds to a multi-destination transfer request or a single-destination transfer request. For example, when data is written to transmit buffer 602, control logic 604 may be triggered to check the configuration register associated with the data to determine if the data corresponds to a multi-destination transfer request or a single-destination transfer request.

Control logic 604 is representative of hardware, software, firmware, or a combination thereof that handles the transfer operations performed by transmit unit 600. For example, control logic 604 may depict a state machine that manages the data that is being read from or written to transmit buffer 602. In an implementation, control logic 604 monitors the storage capacity of transmit buffer 602. For example, control logic 604 may check the availability register to determine when to read data from, or write data to, transmit buffer 602. In an implementation, if control logic 604 determines that there is availability within transmit buffer 602, then control logic 604 outputs a read instruction. For example, control logic 604 may instruct an associated scheduler to schedule a read operation for transferring data into transmit buffer 602. Alternatively, if control logic 604 determines that there is no availability within transmit buffer 602, then control logic 604 outputs a write instruction. For example, control logic 604 may instruct an associated scheduler to schedule a write operation for transferring the data out of transmit buffer 602.

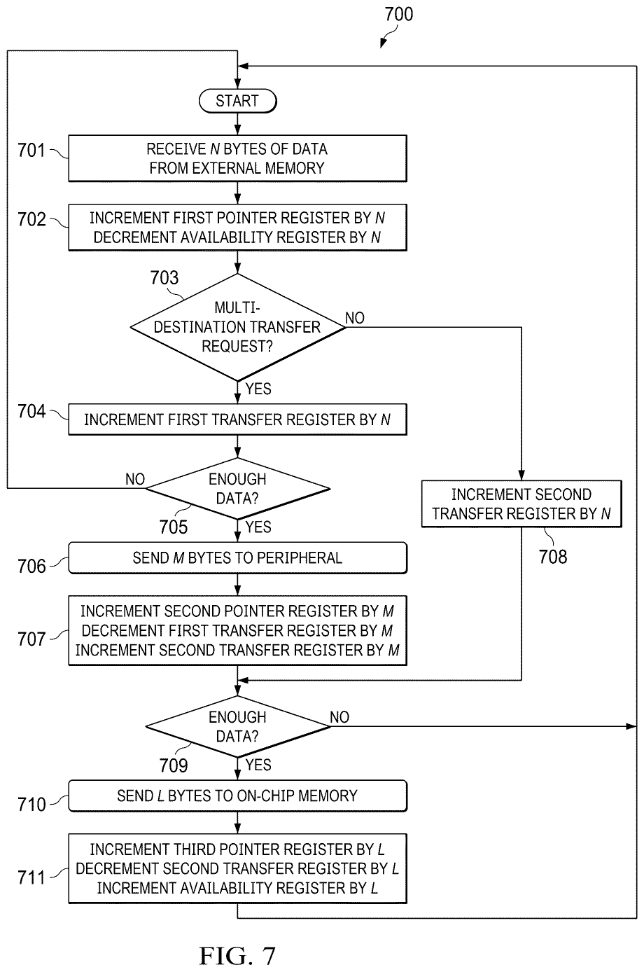

FIG. 7 illustrates state machine process 700 in an implementation. State machine process 700 is representative of a technique, employed by a state machine, for managing the transmission operations of a DMA controller. For example, state machine process 700 may provide a technique for operating the transmit circuitry of a DMA controller implemented within a low-cost system. State machine process 700 may be implemented in the context of hardware, firmware, or software to cause a system to operate as follows, referring parenthetically to the steps in FIG. 7. For the purposes of explanation, state machine process 700 will be explained with respect to the elements of FIG. 6. This specification is not meant to limit the applications of state machine process 700, but rather to provide an example for purposes of illustration.

To begin, transmit unit 600 receives N bytes of data from an external memory and stores the data in RAM 601 (step 701). For example, if transmit unit 600 is representative of transmit unit 406, then transmit unit 600 may receive a boot-up image comprising 32 KB of data from flash memory 417, and in response, store the boot-up image in transmit buffer 602. Once stored, control logic 604 updates the values of transmit registers 603 (step 702). For example, control logic 604 may increase the pointer value stored by the first pointer register by a factor of N and reduce the availability value stored by the availability register by a factor of N. As a result, control logic 604 causes the first pointer register to indicate a new location for writing data into transmit buffer 602 and further causes the availability register to reflect how much space remains within transmit buffer 602.

Next, control logic 604 determines if the recently supplied data corresponds to a single-destination transfer request or a multi-destination transfer request (step 703). For example, if transmit buffer 602 was supplied with a boot-up image, then control logic 604 may check the configuration register associated with the boot-up image to determine if the boot-up image corresponds to a single-destination or multi-destination transfer request.

In an implementation, if the configuration register associated with the boot-up image is enabled, then control logic 604 determines that the boot-up image corresponds to a multi-destination transfer request, and in response, updates the first transfer register of transmit registers 603 (step 704). For example, control logic 604 may increase the transfer value stored by the first transfer register by a factor of N. As a result, control logic 604 causes the first transfer register to indicate how much data is currently available to be transferred to an associated peripheral.

Next, control logic 604 determines if there is enough data to send to the associated peripheral (step 705). For example, if transmit unit 600 represents transmit unit 406, then control logic 604 may analyze the first transfer register to determine if transmit buffer 602 is storing enough data (i.e., M bytes of data) for transmission to crypto engine 413. If the first transfer register indicates that there are less than M bytes of data within transmit buffer 602, then control logic 604 instructs scheduler 403 to schedule a read operation for transferring additional data into transmit buffer 602 (step 701). Alternatively, if the first transfer register indicates that there are M bytes of data, or more than M bytes of data, within transmit buffer 602, then control logic 604 instructs scheduler 403 to schedule a write operation for transferring M bytes of data to crypto engine 413 (step 706). Once transferred, control logic 604 updates the values of transfer register 603 (step 707).

For example, control logic 604 may increase the pointer value of the second pointer register by a factor of M, reduce the transfer value of the first transfer register by a factor of M, and increase the transfer value of the second transfer register by a factor of M. As a result, control logic 604 causes the second pointer register to indicate a new location for reading data out of transmit buffer 602, the first transfer register to indicate how much data is currently available to be transferred to the associated peripheral, and the second transfer register to indicate how much data is currently available to be transferred to an associated on-chip memory.

Next, control logic 604 determines if there is enough data to send to the associated on-chip memory (step 709). For example, if transmit unit 600 represents transmit unit 406, then control logic 604 may analyze the second transfer register to determine if transmit buffer 602 is storing enough data (i.e., L bytes of data) for transmission to on-chip RAM 415. If the second register indicates that there are less than L bytes of data within transmit buffer 602, then control logic 604 instructs scheduler 403 to schedule a read operation for transferring additional data into transmit buffer 602 (step 701). Alternatively, if the second transfer register indicates that there are L bytes of data, or more than L bytes of data, within transmit buffer 602, then control logic 604 instructs scheduler 403 to schedule a write operation for transferring L bytes of data to on-chip RAM 415 (step 710). Once transferred, control logic 604 updates the values of transfer register 603 (step 711).

For example, control logic 604 may increase the pointer value of the third pointer register by a factor of L, reduce the transfer value of the second transfer register by a factor of L, and increase the availability value of the availability register by a factor of L. As a result, control logic 604 causes the third pointer register to indicate a new location for reading data out of transmit buffer 602, the second transfer register to indicate how much data is currently available to be transferred to the associated on-chip memory, and the availability register to indicate how much data is currently available to be transferred to transmit buffer 602.

In another implementation, if the configuration register associated with the boot-up image is disabled, then control logic 604 determines that the boot-up image corresponds to a single-destination transfer request, and in response, updates the second transfer register of transmit registers 603 (step 708). For example, control logic 604 may increment the transfer value stored by the second transfer register by a factor of N. As a result, control logic 604 causes the second transfer register to indicate how much data is currently available to be transferred to an associated on-chip memory.

Next, control logic 604 determines if there is enough data to send to the associated on-chip memory (step 709). For example, if transmit unit 600 represents transmit unit 406, then control logic 604 may analyze the second transfer register to determine if transmit buffer 602 is storing L bytes of data. If the second register indicates that there are less than L bytes of data within transmit buffer 602, then control logic 604 instructs scheduler 403 to schedule a read operation for transferring additional data into transmit buffer 602 (step 701). Alternatively, if the second transfer register indicates that there are L bytes of data, or more than L bytes of data, within transmit buffer 602, then control logic 604 instructs scheduler 403 to schedule a write operation for transferring L bytes of data to on-chip RAM 415 (step 710). Once transferred, control logic 604 updates the values of transfer register 603 (step 711).

For example, control logic 604 may increase the pointer value of the third pointer register by a factor of L, reduce the transfer value of the second transfer register by a factor of L, and increase the availability value of the availability register by a factor of L. As a result, control logic 604 causes the third pointer register to indicate a new location for reading data out of transmit buffer 602, the second transfer register to indicate how much data is currently available to be transferred to the associated on-chip memory, and the availability register to indicate how much data is currently available to be transferred to transmit buffer 602.

Advantageously, state machine process 700 provides a technique that reduces the processing times for performing multi-destination data transfers within the context of a low-cost system that employs a DMA controller. More specifically, state machine process 700 provides a technique for servicing multi-destination transfer requests that only require a single-read from a high latency memory, such as flash memory. As a result, state machine process 700 provides a technique that reduces the processing times for starting up an associated system.

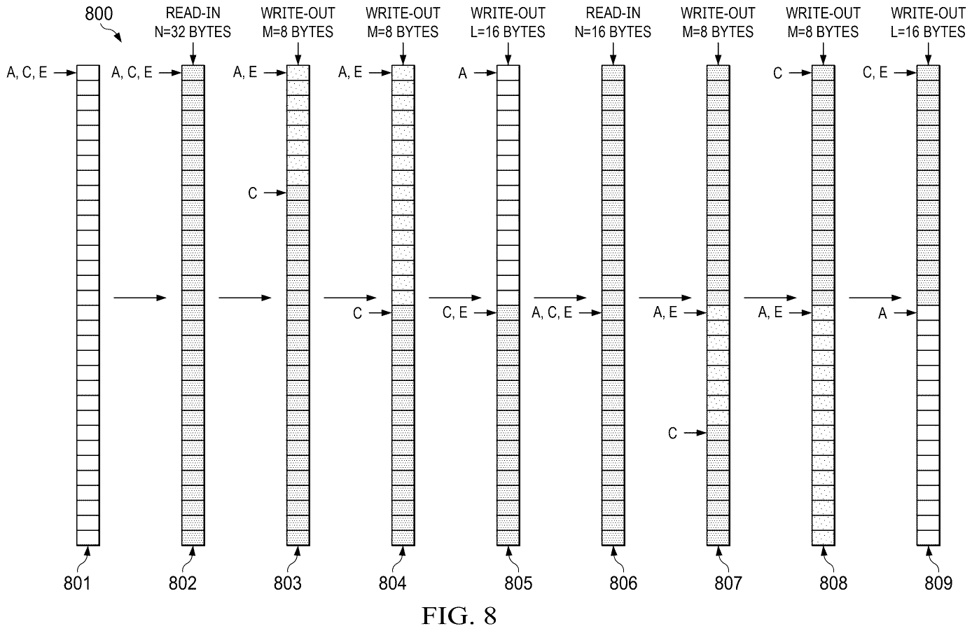

FIG. 8 illustrates operational scenario 800 in an implementation. Operational scenario 800 is representative of an example scenario for writing data into, or reading data out of, a transmit buffer. For example, operational scenario 800 may depict a scenario for reading data into, or writing data out of, transmit buffer 602. For the purposes of explanation, operational scenario 800 will be explained with the elements of FIG. 6. This specification is not meant to limit the applications of operational scenario 800, but rather to provide an example. Operational scenario 800 includes memory locations 801, 802, 803, 804, 805, 806, 807, 808, and 809. Memory locations 801-809 represent the storage units within transmit buffer 602. For example, transmit buffer 602 may include 32 storage units, each capable of storing one byte of data.

To begin, transmit buffer 602 is empty, as depicted by memory locations 801. As a result, the pointer values (i.e., A pointer, C pointer, and E pointer) stored by transmit registers 603 each point to the first storage unit within transmit buffer 602, the availability value stored by transmit registers 603 indicates that there are 32 bytes of availability within transmit buffer 602, and the transfer values stored by transmit registers 603 each indicate that there are zero bytes of available data to transfer from transmit buffer 602.

Next, transmit buffer 602 is supplied with N bytes of data, as depicted by memory locations 802. For example, a boot-up image including 32 bytes of data may be written to transmit buffer 602. As a result, control logic 604 increments the pointer value (i.e., A pointer) of the first pointer register by a factor of 32 and decrements the availability value of the availability register by a factor of 32. For example, control logic 604 may cause the first pointer register to transition from indicating the first storage unit to indicating the thirty-third storage unit, and since transmit buffer 602 only includes 32 storage units, the first pointer register continues to indicate the first storage unit. Additionally, control logic 604 may reduce the availability value from indicating 32 bytes of availability within transmit buffer 602 to indicating 0 bytes of availability within transmit buffer 602.

In an implementation, when transmit buffer 602 is supplied with data, control logic 604 checks the associated configuration register to determine if the data corresponds to a multi-destination transfer request or a single-destination transfer request. For example, control logic 604 may determine that the configuration register for the data is enabled, and in response, increment the transfer value stored by the first transfer register by a factor of 32. As a result, control logic 604 causes the first transfer register to indicate that there is 32 bytes of data currently available to be transferred to an associated peripheral.

Next, control logic 604 determines if there is enough data to send to the associated peripheral. For example, control logic 604 may analyze the first transfer register to determine if there are M bytes (e.g., 8 bytes) of available data. In an implementation, if the first transfer register indicates that there are less than 8 bytes of data within transmit buffer 602, then control logic 604 instructs an associated scheduler to a schedule a read operation for transferring additional data into transmit buffer 602. Alternatively, if the first transfer register indicates that there are at least 8 bytes of data within transmit buffer 602, then control logic 604 instructs the associated scheduler to schedule a write operation for transferring the 8 bytes of data out of transmit buffer 602, as depicted by memory locations 803.

Once transferred to the associated peripheral, control logic 604 increments the pointer value (i.e., C pointer) of the second pointer register by a factor of 8, decrements the transfer value of the first transfer register by a factor of 8, and increments the transfer value of the second transfer register by a factor of 8. As a result, control logic 604 causes the second pointer register to transition from indicating the first storage unit to indicating the ninth storage unit. Additionally, control logic 604 causes the first transfer register to transition from indicating 32 bytes of available data to 24 bytes of available data and the second transfer register to transition from indicating 0 bytes of available data to indicating 8 bytes of available data.

Next, control logic 604 determines if there is enough data to send to the associated on-chip memory. For example, control logic 604 may analyze the second transfer register to determine if there are L bytes (e.g., 16 bytes) of available data. As a result, control logic 604 determines that the second transfer register is currently indicating that there are only 8 bytes of available data, and in response, determines if there is enough data to send to the associated peripheral. For example, control logic 604 may analyze the first transfer register and determine that there are currently 24 bytes of available data, and in response, instructs the associated scheduler to schedule a write operation for transferring 8 bytes of data out of transmit buffer 602, as depicted by memory locations 804.

Once transferred to the associated peripheral, control logic 604 increments the pointer value of the second pointer register by a factor of 8, decrements the transfer value of the first transfer register by a factor of 8, and increments the transfer value of the second transfer register by a factor of 8. As a result, control logic 604 causes the second pointer register to transition from indicating the ninth storage unit to indicating the seventeenth storage unit. Additionally, control logic 604 causes the first transfer register to transition from indicating 24 bytes of available data to 16 bytes of available data and the second transfer register to transition from indicating 8 bytes of available data to indicating 16 bytes of available data.

Next, control logic 604 determines if there is enough data to send to the associated on-chip memory. For example, control logic 604 may analyze the second transfer register to determine if there are L bytes (e.g., 16 bytes) of available data. As a result, control logic 604 determines that there are currently 16 bytes of available data, and in response, instructs the associated scheduler to schedule a write operation for transferring the 16 bytes of data out of transmit buffer 602, as depicted by memory locations 805.

Once transferred to the associated on-chip memory, control logic 604 increments the pointer value (i.e., E pointer) of the third pointer register by a factor of 16, decrements the transfer value of the second transfer register by a factor of 16, and increments the availability value of the availability register by a factor of 16. As a result, control logic 604 causes the third pointer register to transition from indicating the first storage unit to indicating the seventeenth storage unit. Control logic 604 also causes the second transfer register to transition from indicating 16 bytes of available data to indicating 0 bytes of available data. Additionally, control logic 604 causes the availability value of the availability register to increase from indicating 0 bytes of availability to 16 bytes of availability.

Next, control logic 604 instructs the associated scheduler to schedule a read operation for transferring 16 bytes of data to transmit buffer 602, as depicted by memory locations 806. Once transferred, control logic 604 causes the first pointer register to transition from indicating the first storage unit to indicating the seventeenth storage unit. Additionally, control logic 604 reduces the availability value from indicating 16 bytes of availability to indicating 0 bytes of availability within transmit buffer 602.

After updating transmit register 603, control logic 604 determines if there is enough data to send to the associated peripheral. For example, control logic 604 may analyze the first transfer register and determine that there are currently 16 bytes of available data, and in response, instructs the associated scheduler to schedule a write operation for transferring 8 bytes of data out of transmit buffer 602, as depicted by memory locations 807. Once transferred to the associated peripheral, control logic 604 causes the second pointer register to transition from indicating the seventeenth storage unit to indicating the twenty-fifth storage unit. Additionally, control logic 604 causes the first transfer register to transition from indicating 16 bytes of available data to 8 bytes of available data and the second transfer register to transition from indicating 0 bytes of available data to indicating 8 bytes of available data.

Next, control logic 604 determines if there is enough data to send to the associated on-chip memory. For example, control logic 604 may determine that the second transfer register is currently indicating that there are only 8 bytes of available data, and in response, determines if there is enough data to send to the associated peripheral. As such, control logic 604 may analyze the first transfer register and determine that there are currently 8 bytes of available data, and in response, instructs the associated scheduler to schedule a write operation for transferring the 8 bytes of data out of transmit buffer 602, as depicted by memory locations 808.

Once transferred to the associated peripheral, control logic 604 increments the pointer value of the second pointer register by a factor of 8, decrements the transfer value of the first transfer register by a factor of 8, and increments the transfer value of the second transfer register by a factor of 8. As a result, control logic 604 causes the second pointer register to transition from indicating the twenty-fifth storage unit to indicating the first storage unit. Additionally, control logic 604 causes the first transfer register to transition from indicating 8 bytes of available data to 0 bytes of available data and the second transfer register to transition from indicating 8 bytes of available data to indicating 16 bytes of available data.

Next, control logic 604 determines if there is enough data to send to the associated on-chip memory. For example, control logic 604 may determine that the second transfer register is currently indicating that there are 16 bytes of available data, and in response, instructs the associated scheduler to schedule a write operation for transferring the 16 bytes of data out of transmit buffer 602, as depicted by memory locations 809. Once transferred to the associated on-chip memory, control logic 604 increments the pointer value of the third pointer register by a factor of 16, decrements the transfer value of the second transfer register by a factor of 16, and increments the availability value of the availability register by a factor of 16. As a result, control logic 604 causes the third pointer register to transition from indicating the seventeenth storage unit to indicating the first storage unit. Control logic 604 also causes the second transfer register to transition from indicating 16 bytes of available data to indicating 0 bytes of available data. Additionally, control logic 604 causes the availability value of the availability register to increase from indicating 0 bytes of availability to 16 bytes of availability.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. Direct memory access (DMA) circuitry comprising:
a transmit buffer; and
control circuitry operable to, in response to a request to transfer data from a source to multiple destinations:
control transferring of the data from the source to the transmit buffer;
control transferring of the data from the transmit buffer to a first destination of the multiple destinations; and
control transferring of the data from the transmit buffer to a second destination of the multiple destinations.

2. The DMA circuitry of claim 1 further including a state machine operable to determine that the request is a multi-destination request based on a transfer descriptor for the request.

3. The DMA circuitry of claim 2, wherein the transfer descriptor for the request comprises a bit-field that identifies a source address associated with the source for the data and destination addresses associated with the multiple destinations for the data.

4. The DMA circuitry of claim 1, wherein the source comprises an external memory, wherein the first destination of the multiple destinations comprises a peripheral device, and wherein the second destination of the multiple destinations comprises an on-chip memory.

5. The DMA circuitry of claim 4, wherein the data comprises a boot-up image, wherein the peripheral device includes an authentication engine operable to authenticate the boot-up image, and wherein the on-chip memory is coupled to processing circuitry operable to start-up an associated system using the boot-up image.

6. The DMA circuitry of claim 1 further comprising read circuitry, and wherein to control the transferring of the data from the source to the transmit buffer, the control circuitry is operable to direct the read circuitry to read the data from the source to the transmit buffer.

7. The DMA circuitry of claim 1 further comprising write circuitry, and wherein to control the transferring of the data from the transmit buffer to the first destination, the control circuitry is operable to direct the write circuitry to write the data from the transmit buffer to the first destination.

8. The DMA circuitry of claim 7, wherein to control the transferring of the data from the transmit buffer to the second destination, the control circuitry is further operable to direct the write circuitry to write the data from the transmit buffer to the second destination.

9. Transmit channel circuitry comprising:
a transmit buffer; and
control circuitry operable to, in response to a request to transfer data from a source to multiple destinations:
control transferring of the data from the source to the transmit buffer;
control transferring of the data from the transmit buffer to a first destination of the multiple destinations; and
control transferring of the data from the transmit buffer to a second destination of the multiple destinations.

10. The transmit channel circuitry of claim 9 further including a state machine operable to determine that the request is a multi-destination request based on a transfer descriptor for the request, and wherein the transfer descriptor for the request comprises a bit-field that identifies a source address associated with the source for the data and destination addresses associated with the multiple destinations for the data.

11. The transmit channel circuitry of claim 9, wherein the source comprises an external memory, wherein the first destination of the multiple destinations comprises a peripheral device, and wherein the second destination of the multiple destinations comprises an on-chip memory.

12. The transmit channel circuitry of claim 11, wherein the data comprises a boot-up image, wherein the peripheral device includes an authentication engine operable to authenticate the boot-up image, and wherein the on-chip memory is coupled to processing circuitry operable to start-up an associated system using the boot-up image.

13. The transmit channel circuitry of claim 9, wherein to control the transferring of the data from the source to the transmit buffer, the control circuitry is operable to direct read circuitry to read the data from the source to the transmit buffer.

14. The transmit channel circuitry of claim 9, wherein to control the transferring of the data from the transmit buffer to the first destination, the control circuitry is operable to direct write circuitry to write the data from the transmit buffer to the first destination, and wherein to control the transferring of the data from the transmit buffer to the second destination, the control circuitry is further operable to direct the write circuitry to write the data from the transmit buffer to the second destination.

15. A system comprising:
processing circuitry operable to send a transfer request for data; and
direct memory access (DMA) circuitry operable to receive the transfer request, wherein the DMA circuitry comprises:
a transmit buffer; and
control circuitry operable to, in response to the transfer request:
control transferring of the data from a source to the transmit buffer;
control transferring of the data from the transmit buffer to a first destination of multiple destinations; and
control transferring of the data from the transmit buffer to a second destination of the multiple destinations.

16. The system of claim 15 further including a state machine operable to determine that the transfer request is a multi-destination request based on a transfer descriptor for the transfer request, and wherein the transfer descriptor for the transfer request comprises a bit-field that identifies a source address associated with the source for the data and destination addresses associated with the multiple destinations for the data.

17. The system of claim 15, wherein the source comprises a flash memory, wherein the first destination of the multiple destinations comprises a peripheral device, and wherein the second destination of the multiple destinations comprises an on-chip memory of the processing circuitry.

18. The system of claim 17, wherein the data comprises a boot-up image, wherein the peripheral device includes an authentication engine operable to authenticate the boot-up image, and wherein the processing circuitry is operable to start-up the system using the boot-up image.

19. The system of claim 15, wherein the DMA circuitry further comprises read circuitry, and wherein to control the transferring of the data from the source to the transmit buffer, the control circuitry is operable to direct the read circuitry to read the data from the source to the transmit buffer.

20. The system of claim 15, wherein the DMA circuitry further comprises write circuitry, and wherein to control the transferring of the data from the transmit buffer to the first destination of the multiple destinations, the control circuitry is operable to direct the write circuitry to write the data from the transmit buffer to the first destination, and wherein to control the transferring of the data from the transmit buffer to the second destination of the multiple destinations, the control circuitry is further operable to direct the write circuitry to write the data from the transmit buffer to the second destination.
